(19) United States
(12) Patent Application Publication
(10) Pub. No.: US 2010/0234971 A1
(43) Pub. Date: Sep. 16, 2010

(54) AUDIO SIGNAL PROCESSING APPARATUS

(75) Inventors: Hideki HAGIWARA, Hamamatsu-shi (JP); Masaaki Okabayashi, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 12/721,221

(22) Filed: Mar. 10, 2010

(30) Foreign Application Priority Data
Mar. 10, 2009 (JP) 2009-56077

(51) Int. Cl. G06F 17/00

(52) U.S. Cl. 700/94

(57) ABSTRACT

An audio signal processing apparatus, which has a plurality of channels each processing input signals in accordance with parameters, is provided with a plurality of batch control functions which serve different batch control functions each of which controls, all at once, parameters of two or more channels included in the plurality of channels. The audio signal processing apparatus also has an isolated channel designating portion for designating any channel of the channels as an isolated channel. The channel designated as an isolated channel by the isolated channel designating portion is prohibited from undergoing the batch control of parameter values by the batch control function portions.

### BACKGROUND OF THE INVENTION

1. Field of the Invention

The present invention relates to an audio signal processing apparatus which facilitates isolation of a desired channel from a plurality of batch control functions each of which manipulates two or more channels all at once.

2. Description of the Related Art

As an audio signal processing apparatus, conventionally, a mixing apparatus for use in a concert hall and the like has been known (see Japanese Unexamined Patent Publication No. 2006-262079) which allows adjustment of the level and frequency response of audio signals output from a multiplicity of microphones, an electric/electronic musical instrument and the like to mix the adjusted audio signals to send the mixed audio signals to a power amplifier. A manipulator of the conventional mixing apparatus controls the tone volume and tone colors of respective audio signals indicative of musical tones of musical instruments and vocals by manipulating various kinds of panel operators of the mixing apparatus. The mixing apparatus has a plurality of input channels serving as channels for inputting signals, buses for mixing signals output from the input channels, and output channels serving as channels for outputting the mixed signals. The respective input channels control the frequency response, the mixing level and the like of the input signals and then output the controlled signals to the mixing buses, respectively, whereas the respective mixing buses mix the input signals and then output to corresponding output channels. The outputs from the output channels are amplified to be emitted as tones from speakers and the like.

### SUMMARY OF THE INVENTION

The conventional mixing apparatus is able to store all the parameters set by the manipulator by use of the operators such as faders, knobs and switches provided on a panel as scene data in a scene memory or the like. Each set of scene data is given a scene number to be stored, so that the manipulator designates a scene number in order to recall scene data. The scene data having the designated scene number is then read out so that the mixing apparatus can reproduce settings defined by the scene data. Therefore, the conventional mixing apparatus is able to reproduce various kinds of scenes such as conference rooms, banquet halls, mini theaters and multi-purpose halls which the manipulator has once programmed. In some cases of the scene recall, however, the manipulator desires to prevent recalling of parameter values of a certain channel. In order to meet such need, the conventional mixing apparatus has a recall safe function of preventing recalling of parameters of a certain channel. In order to activate the recall safe function, the manipulator is required to move to an edit screen for the recall safe function to select a channel for which the manipulator desires to activate the recall safe function to activate the recall safe function for the channel. By such procedures, the conventional mixing apparatus prevents recalling of the parameters of the channel in spite of scene recall, retaining the current parameter values for the channel.

In addition, the conventional mixing apparatus has a channel link function. The channel link function allows creation of a channel link group in which two or more channels are linked in order to allow linkage of a manipulation of a fader and a manipulation of a parameter of an equalizer and the like among the channels belonging to the channel link group. More specifically, a manipulation of a parameter of one of the linked channels results in linked manipulations of the same parameter of the other channels which belong to the channel link group. On the conventional mixing apparatus, although the settings of the channel link function are stored as part of a scene, the channel link function is not included in those to be affected by the recall safe function. If the scene is recalled, therefore, the conventional mixing apparatus always reproduces the settings of the channel link as well. Furthermore, the conventional mixing apparatus also has a function of creating a channel group referred to as a DCA (Digital Controlled Amplifier) group having a plurality of channels as a group to allow the manipulator to manipulate the respective levels of the respective channels belonging to the DCA group all at once. In addition, the conventional mixing apparatus also has a function of creating a channel group referred to as a mute group having a plurality of channels as a group to allow the manipulator to switch the respective mute states of the channels belonging to the mute group between on and off all at once.

However, in a case where due to occurrence of a problem on a channel, the manipulator desires to isolate the erroneous channel from a scene recall, the manipulator is required to move to an edit screen of the recall safe function to activate the recall safe function for the erroneous channel so that the erroneous channel will be isolated from the scene recall function. Furthermore, in a case where due to occurrence of a problem on a channel-linked channel, the manipulator desires to isolate the erroneous channel from the channel link function, the manipulator is required to move to an edit screen of the channel link function to isolate the erroneous channel from the channel link function, separately from the procedure made in the edit screen of the recall safe function. In a case where the manipulator desires to isolate a channel from a DCA group or a mute group as well, the manipulator is desired to move to an edit screen of the DCA group function or the mute group function. Disadvantageously, as described above, the conventional mixing apparatus requires the manipulator to do quite troublesome and time-consuming procedures in order to ensure a secure state after the occurrence of the problems, being unable to promptly provide a secure state.

An object of the present invention is to provide an audio signal processing apparatus which facilitates isolation of a desired channel from a plurality of batch control functions each of which manipulates two or more channels included in a plurality of channels all at once.

In order to achieve the above-described object, the present invention provides an audio signal processing apparatus including a signal processing portion (18, 33a to 33n, 35a to 35m) formed of a plurality of channels each processing an input signal in accordance with a parameter; a parameter setting portion (15, 16, 50, 51, 53, 54, 102) for setting a value of a parameter for each of the channels; a plurality of batch control function portions (S20, S22, S32 to S38, S41, S51) each performing a different batch control function which controls, all at once, respective parameter values of two or more channels included in the plurality of channels; an isolated channel designating portion (50c, 64, 71, 73, 103a, 104a, 104c) for designating any channel of the plurality of channels as an isolated channel; an isolation portion (12, S10, S21, S30, S31, S40, S50) for allowing batch control of respective parameter values by the batch control function portions for a channel which has not been designated as an isolated channel by the isolated channel designating portion and prohibiting batch control of respective parameter values by the batch control function portions for the channel which has been designated as an isolated channel by the isolated channel designating portion.

In this case, the channels whose parameter values are to be controlled all at once by the batch control function portions are designated independently function by function served by the batch control function portions (S2, S3, S4, S5).

Furthermore, the plurality of batch control functions are at least two of, for example, a scene function (S20, S22) of reading out, all at once, changed values of various parameters stored as scene data and then controlling, all at once, respective values of the parameters in accordance with the read changed values; a channel link function (S32 to S38) of controlling, all at once, respective values of various parameters of a plurality of channels grouped as a link group; a DCA group function (S41) of controlling, all at once, respective values of signal level of a plurality of channels grouped as a DCA group; and a mute group function (S51) of controlling, all at once, respective on/off states of mute of a plurality of channels grouped as a mute group.

In addition, the parameter setting portion may include a plurality of parameter operating portions (51, 53, 54, 102) assigned to the plurality of channels, respectively, in order to set respective parameter values of the plurality of channels. The parameter setting portion may include a channel selection switch (64, 73) for selecting any channel of the plurality of channels; and a parameter operator (50a, 50c) for setting a parameter of the channel selected by the channel selection switch.

Furthermore, the isolated channel designating portion is a plurality of isolation switches (71), for example, assigned to the plurality of channels, respectively, in order to designate the channels as isolated channels, respectively. In addition, the isolated channel designating portion may include a channel selection operator (64, 73, 104c) for selecting any channel of the plurality of channels; and an isolation switch (50c, 103a, 104a) for designating the channel selected by the channel selection operator as an isolated channel.

Furthermore; the isolation portion has flag memory (12, S10) for storing a plurality of flags provided to correspond to the plurality of channels, respectively, and set by the isolated channel designating portion to indicate whether the plurality of channels have been designated as isolated channels, respectively, and prohibits, by use of the plurality of flags stored in the flag memory, batch control of respective parameter values by the plurality of batch control function portions (S21, S30, S31, S40, S50).

By designating a desired channel as an isolated channel by the isolated channel designating portion, the audio signal processing apparatus according to the present invention is able to prohibit the batch control of respective parameter values by the batch control function portions for the channel designated as an isolated channel. In other words, the audio signal processing apparatus is able to isolate the desired channel designated as an isolated channel from the batch control functions which have been set for the channel. Therefore, the audio signal processing apparatus facilitates isolation of a desired channel from the batch manipulation functions which allow manipulation of two or more channels included in a plurality of channels all at once. Even on occurrence of a problem on a channel, as a result, the audio signal processing apparatus allows easy, quick and correct isolation of the erroneous channel to promptly ensure a safe state, enhancing safety of a system.

### BRIEF DESCRIPTION OF THE DRAWINGS

FIG. 1 is a block diagram indicating the configuration of a mixing apparatus which is an embodiment of an audio signal processing apparatus of the present invention;

FIG. 2 is an equivalent functional block diagram indicating mixing processing performed by a signal processing portion of the mixing apparatus of the present invention and input/output ports of a waveform I/O used for the mixing processing;

FIG. 3 is a configuration of a panel of the mixing apparatus according to the present invention;

FIG. 4 is an enlarged view of part of the panel of the mixing apparatus according to the present invention;

FIG. 5 is an enlarged view of a configuration of a channel strip provided on the panel of the mixing apparatus according to the present invention;

FIG. 6 is a configuration of an isolation icon displayed on a display unit of the mixing apparatus according to the present invention;

FIG. 7 is a flowchart of an isolation switch process carried out by the mixing apparatus according to the present invention;

FIG. 8 is a table of isolation flags set on the mixing apparatus according to the present invention;

FIG. 9A is a flowchart of a scene storing process carried out by the mixing apparatus according to the present invention;

FIG. 9B is a flowchart of a scene recall process carried out by the mixing apparatus according to the present invention;

FIG. 10A is a flowchart of a channel link setting process carried out by the mixing apparatus according to the present invention;

FIG. 10B is a flowchart of a channel link process carried out by the mixing apparatus according to the present invention;

FIG. 11A is a flowchart of a DCA group setting process carried out by the mixing apparatus according to the present invention;

FIG. 11B is a flowchart of a DCA group process carried out by the mixing apparatus according to the present invention;

FIG. 12A is a flowchart of a mute group setting process carried out by the mixing apparatus according to the present invention; and

FIG. 12B is a flowchart of a mute group process carried out by the mixing apparatus according to the present invention.

### DESCRIPTION OF THE PREFERRED EMBODIMENT

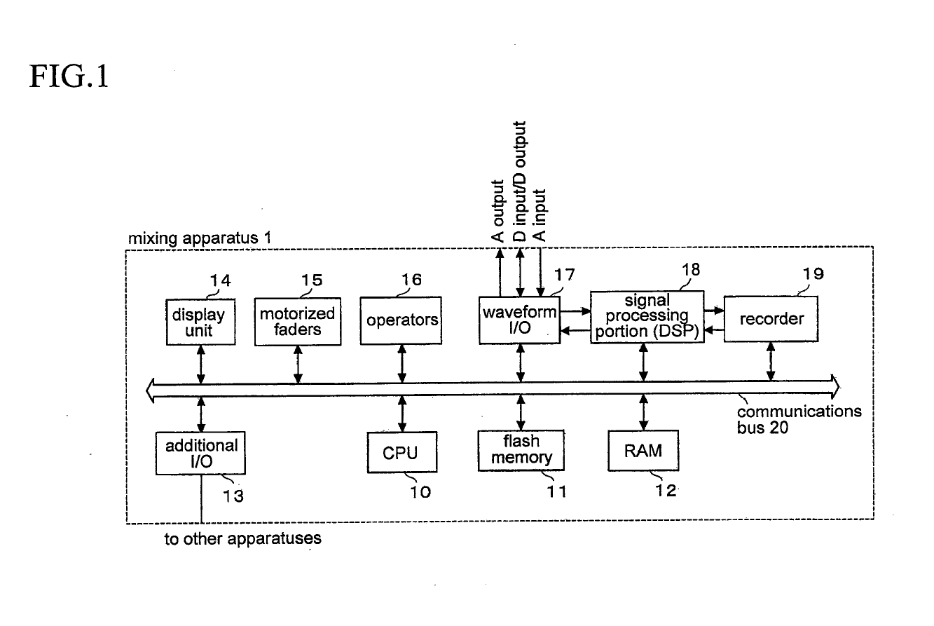

FIG. 1 is a block diagram indicating the configuration of a mixing apparatus 1 which is an embodiment of the audio signal processing apparatus of the present invention.

The mixing apparatus 1 includes a CPU (Central Processing Unit) 10 which controls the entire operation of the mixing apparatus 1 and generates control signals in accordance with user's manipulations of various operators provided on a panel, a rewritable nonvolatile flash memory 11 which stores operational software such as a mixing control program executed by the CPU 10, and a RAM (Random Access Memory) 12 which serves as a working area for the CPU 10 to store various kinds of data. Because the operational software is stored in the flash memory 11, the mixing apparatus 1 allows updates of the operational software by rewriting the operational software stored in the flash memory 11. Furthermore, other apparatuses such as a digital recorder are connected to the mixing apparatus 1 via an additional I/O 13 which is an input/output interface.

A display unit 14, which is configured of a liquid crystal display, displays setting screens on which a user sets parameters of respective channels assigned to later-described assignment strips. In a case where the assignment strips have been assigned DCA groups (Digital Controlled Amplifier), the display unit 14 serves as a touch panel for displaying channels belonging to the DCA groups. Motorized faders 15, which are faders for controlling the level of signals of input channels or signals of output channels, are operated manually or motor-operated. Operators 16 include various kinds of operators such as switches and knobs provided on the panel, and touch-switches displayed on the display unit 14 serving as the touch panel. The CPU 10 scans the operators 16 to detect operating events of the switches, knobs and the touch panel. Every input and every output on the mixing apparatus 1 is made via a waveform I/O (waveform data interface) 17. The waveform I/O 17 has a plurality of A input ports to which analog signals are input, a plurality of A output ports to which analog signals are output and a plurality of D input/D output ports to which digital signals are externally input/output bidirectionally.

A signal processing portion 18, which includes a multiplicity of DSPs (Digital Signal Processors), carries out mixing processing and effect processing under the control of the CPU 10. The RAM 12 is provided with a current area which stores respective current values of various parameters set in the signal processing portion 18 in order to control the mixing processing and effect processing. In accordance with a manipulation of the operators 16, the CPU 10 changes a current value of a parameter stored in the current area of the RAM 12. When any change is made to the parameter value, the changed current value is reflected in the signal processing portion 18 as well to control coefficients and algorithms used for the mixing processing and the effect processing performed by the signal processing portion 18. Mixing signals mixed by the signal processing portion 18 can be supplied to a recorder 19 to be stored in the recorder 19. In addition, mixing signals reproduced by the recorder 19 can be supplied to the signal processing portion 18. In this case, the recorder 19 is allowed to compress mixing signals before storage and to expand reproduced mixing signals before output. The respective portions of the mixing apparatus 1 receive and transmit data between each other via a communications bus 20 formed of a control bus, an address bus and a data bus.

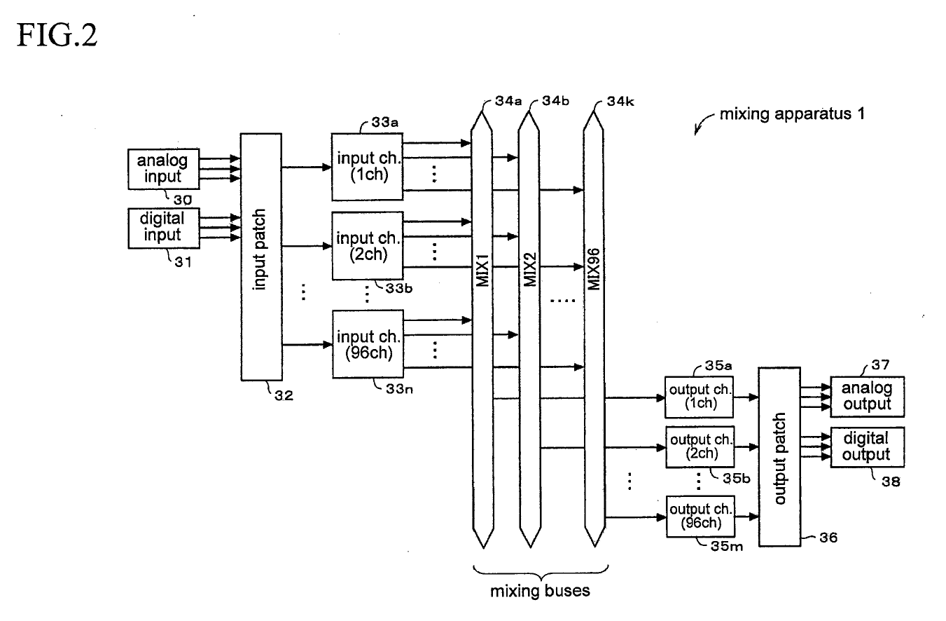

FIG. 2 is an equivalent functional block diagram indicating the mixing processing performed by the signal processing portion 18 of the mixing apparatus 1 and the input/output ports of the waveform I/O 17 used for the mixing processing.

In FIG. 2, a plurality of analog signals input to a plurality of analog input ports (A input) 30 are converted into digital signals by an AD converter incorporated into the waveform I/O 17 to be input to an input patch 32. A plurality of digital signals input to a plurality of digital input ports (D input) 31 are input to the input patch 32 directly. The input patch 32 is allowed to selectively patch (connect) one of the input ports from which the signals are input to one of input channels 33a, 33b, . . . 33n of 96 channels, for example. To the respective input channels 33a, 33b, . . . 33n, signals transmitted from the respective input ports patched by the input patch 32 are supplied.

Each of the input channels 33a to 33n is provided with an attenuator, an equalizer, a compressor, a gate, a fader, a send control portion for controlling the send level to mixing buses 34a, 34b, . . . 34k and the like. In the respective input channels 33a to 33n, the frequency balance, the send level to the mixing bus 34a to 34k, and the like are controlled. The digital signals of the 96 channels output from the input channels 33a to 33n are selectively output to one or more of the 96 mixing buses 34a to 34k, respectively. In each of the 96 mixing buses 34a to 34k, one or more digital signals selectively input from one or more of the 96 input channels 33a to 33n are mixed, so that the mixed outputs for the total of 96 channels are output to output channels 35a, 35b, . . . 35m. As a result, the mixing apparatus 1 is able to obtain the 96 different mixed outputs of the 96 channels.

Each of the output channels 35a to 35m is provided with an attenuator, an equalizer, a compressor, a fader and the like. In the respective output channels 35a to 35m, the frequency balance, the send level to an output patch 36, and the like are controlled. The output patch 36 is allowed to selectively patch (connect) one of the 96 output channels 35a to 35m from which the signals are input to output ports of an analog output port portion (A output) 37 and a digital output port portion (D output) 38. To the respective output ports, signals transmitted from the output channels patched by the output patch 36 are supplied.

Digital output signals supplied to the analog output port portion (A output) 37 having the plurality of analog output ports are converted into analog output signals by a DA converter incorporated in the waveform I/O 17 to be output from the analog output ports. The analog output signals output from the analog output port portion (A output) 37 are amplified to be emitted from main speakers. In addition, the analog output signals are also supplied to in-ear monitors worn by performers in their ears or reproduced by stage-monitoring speakers placed near the performers. The digital audio signals output from the digital output port portion (D output) 38 having the plurality of digital output ports are supplied to a recorder, an externally connected DAT (Digital Audio Tape Recorder), and the like to allow digital recording.

The mixing apparatus 1 has functions of controlling parameters of a plurality of channels all at once (concurrently controlling respective parameters of a plurality of channels by one manipulation). These functions include a scene function, a channel link function, a DCA group function and a mute group function. Hereafter, these functions will be generically called batch control functions. The scene function is the function of reading out, all at once, changed values of various parameters stored as scene data and controlling the current values of the various parameters all at once stored in the current area in accordance with the read changed values (the function of replacing the current values with the changed values). The scene function is provided with a recall safe function of retaining a current value of a user's designated channel or parameter without replacing the current value with the changed value stored as scene data. The channel link function is the function of bringing a plurality of channels into a link group to control respective values of various parameters of the respective channels belonging to the link group all at once. More specifically, the channel link function is the function of replacing, when a current value of a parameter of a channel belonging to the link group has been changed (for example, when a current value of a signal level of the channel has been changed by use of a fader provided for the channel on a channel strip portion), respective current values of the parameter of the other channels belonging to the link group with the same value as the changed current value of the channel (or with values into which the amount of changed value of the channel has been factored).

The DCA group function is the function of bringing a plurality of channels into a DCA group to control respective values of the signal level of the channels belonging to the DCA group all at once. More specifically, the DCA group function is the function of setting, when a value of the DCA signal level shared by all the channels belonging to the DCA group has been changed by use of a DCA fader (a fader provided on an assignment strip portion), respective values obtained on the basis of the changed DCA signal level and respective current values of the signal level of the respective channels belonging to the DCA group in the signal processing portion 18 as respective updated signal levels of the respective channels. When the value of the DCA signal level is changed, the respective current values of the signal level of the respective channels belonging to the DCA group stored in the current area will not be rewritten. The mute group function is the function of bringing a plurality of channels into a mute group to control the on/off states of the mute of the respective channels belonging to the mute group all at once. More specifically, the mute group function is the function of switching, when a demand for switching the on/off states of the mute of a mute group has been made (when a mute switch for the mute group has been depressed), the current on/off state of the mute of all the channels belonging to the mute group from on to off (or off to on).

Furthermore, the mixing apparatus 1 has a function of temporarily isolating a given channel from all the batch control functions to which the channel belongs. Isolating the channel from the batch control functions is achieved by controlling the setting of the channel such that the execution of the batch control functions will not involve parameter control over the channel, that is, such that the parameter control that would be performed by the execution is ignored or disabled in the channel so that the execution of the batch control functions will not affect the channel. Hereafter, such a function will be referred to as an isolation function. The setting of the isolation function can be made for each channel. A channel programmed such that the isolation function is active is isolated from all the batch control functions to which the channel belongs as long as the isolation function is active. More specifically, the channel is isolated, with setting information on the batch control functions of the channel being retained. That is, when the isolation of the channel is activated, the setting information on the various kinds of batch control functions stored in the RAM 12 (setting information stored in a scene function area, a channel link function area, a DCA group area and a mute group function area) will not be rewritten.

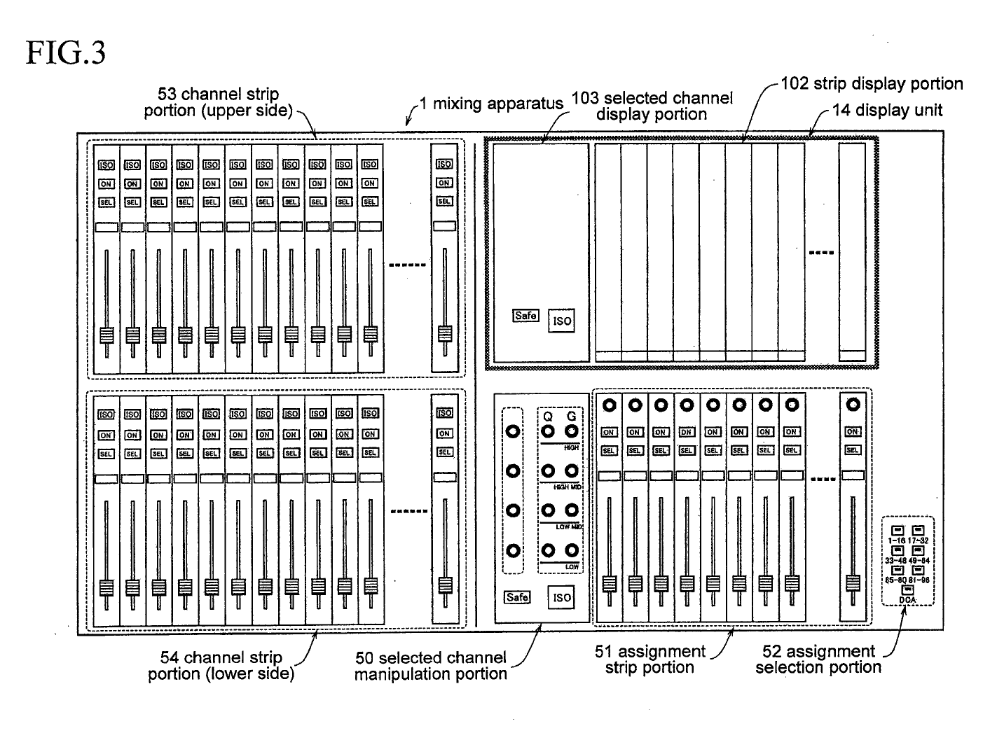

FIG. 3 indicates the configuration of a panel provided on the mixing apparatus 1. The panel of the mixing apparatus 1 indicated in FIG. 3 has the display unit 14 which is a touch panel provided on the upper part of the right side, and a selected channel manipulation portion 50 and an assignment strip portion 51 provided below the display unit 14. On the right side of the assignment strip portion 51, an assignment selection portion 52 is provided. On the upper part of the left half of the panel, a channel strip portion (upper side) 53 is provided, whereas a channel strip portion (lower side) 54 is provided below the channel strip portion 53. The channel strip portion (upper side) 53 and the channel strip portion (lower side) 54 have 32 channel strips, respectively, for example, with each channel strip being assigned a channel included in 32 input channels selected by use of a layer switch which is not shown. Each channel strip provided for the channel strip portion (upper side) 53 and the channel strip portion (lower side) 54 is provided with a fader for setting the volume of an input channel assigned to the channel strip, a display portion on which a channel number or a channel name is displayed, a SEL switch for selecting the input channel, an ON switch for switching the channel between on and off, and an isolation switch (ISO) for demanding the start or halt of the isolation function, as indicated in the figure.

The assignment strip portion 51 is formed of 16 strip portions which are allowed to control fundamental parameters. The assignment strip portion 51 is allowed to be assigned input channels of 16 channels, also being allowed to be assigned DCA groups of up to 16 groups. The display unit 14, which is a touch panel, displays a strip display portion 102 and a selected channel display portion 103. Each strip displayed on the strip display portion 102 displays operators of minute parameters of an input channel assigned to the strip portion situated immediately below the strip. The operators of minute parameters displayed on each strip of the strip display portion 102 are those which cannot be manipulated by the channel strip portions 53, 54. Such operators will be described later in detail. Each strip portion of the assignment strip portion 51 is provided with a fader for manipulating the level of an assigned input channel/DCA group, a display portion on which a channel/group number and a channel/group name is displayed, a SEL switch for selecting the assigned channel, an ON switch for switching between on and off, and a knob for setting a parameter. The assignment of channels to the assignment strip portion 51 is done by use of the assignment selection portion 52. In a shown example, the assignment selection portion 52 has switches for dividing the input channels from the first input channel to the 96th input channels into groups each having 16 channels to assign a group of 16 channels (1 to 16, 17 to 32, 33 to 48, 49 to 64, 65 to 80, and 81 to 96), and a DCA switch for assigning DCA groups of up to 16 groups.

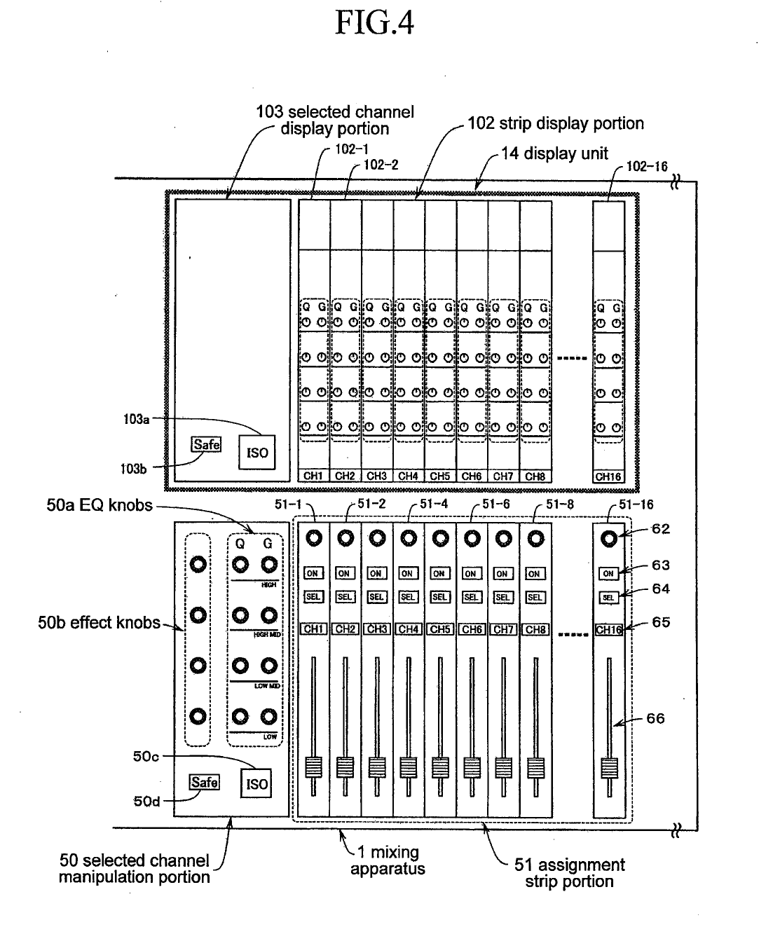

FIG. 4 is an enlarged view indicating a part of the panel, the part being situated on the right of the channel strip portions 53, 54. Referring to FIG. 4, the part of the panel will be described. In FIG. 4, the display unit 14 displays a state in which the first input channel (CH1) to the sixteenth input channel (CH16) are assigned to the assignment strip portion 51.

On manipulation of the switch (1 to 16) provided on the assignment selection portion 52, the channels CH1 to CH16 are assigned to 16 assignment strips 51-1, 51-2, . . . , 51-16, respectively, provided on the assignment strip portion 51, with a display portion 65 of each of the assignment strips 51-1 to 51-16 displaying an assigned input channel number. The 16 assignment strips 51-1 to 51-16 are configured similarly. More specifically, each of the assignment strips 51-1 to 51-16 has a control knob 62 for setting a value of a parameter, an ON switch 63 for switching an input channel assigned to the assignment strip between on and off, a SEL switch 64 for selecting the assigned input channel, the display portion 65 for displaying a channel number or a channel name, and a fader 66 having a fader knob for setting a level of the assigned input channel. The parameter which is to be controlled by the control knob 62 can be selected on the strip display portion 102.

As indicated in the figure, as if the 16 vertically long assignment strips 51-1 to 51-16 were extended, 16 strips 102-1, 102-2, . . . , 102-16 corresponding to the 16 assignment strips 51-1 to 51-16 are displayed on the strip display portion 102. The strips 102-1 to 102-16 display the assigned input channel numbers, respectively. Each of the strips 102-1 to 102-16 displays a plurality of icons indicative of knobs corresponding to parameters of equalizers. The equalizers are configured to have functions similar to those of EQ knobs 50a provided on the selected channel manipulation portion 50. More specifically, the EQ knobs 50a have a total of 8 knobs for controlling the selectivity (Q) and the gain (G) of respective bands divided into four frequency bands of a HIGH band, a HIGH MID band, a LOW MID band, and a LOW band. The strips 102-1 to 102-16 display corresponding knobs, respectively. On the strips 102-1 to 102-16 which are displayed on the touch panel, when the user touches a knob icon of a parameter which he desires to control, the parameter is selected so that the user may control the selected parameter by manipulating the control knob 62 of the assignment strip 51-1 to 51-16 provided right below the strip where the touched knob icon is placed.

When the user manipulates the SEL switch of any of the channel strips provided on the channel strip portion (upper side) 53 and the channel strip portion (lower side) 54, the input channel assigned to the channel strip on which the manipulated SEL switch is provided is assigned to the selected channel display portion 103 and the selected channel manipulation portion 50 as a selected channel. Alternatively, when the user manipulates the SEL switch 64 of any of the assignment strips 51-1 to 51-16, the input channel assigned to the assignment strip 51-1 to 51-16 on which the manipulated SEL switch 64 is provided is assigned to the selected channel display portion 103 and the selected channel manipulation portion 50. By such an assignment of the input channel, the mixing apparatus 1 allows the user to control parameters of the selected input channel by use of operators which are provided on the selected channel display portion 103 but are not shown, with the on/off state of the recall safe of the selected channel being indicated by a display icon (Safe) 103b provided on the selected channel display portion 103. When the user touches an isolation switch icon (ISO) 103a displayed on the selected channel display portion 103, the isolation function is activated for the selected input channel.

Furthermore, the mixing apparatus 1 allows the user to control the parameters of the equalizers of the selected input channel by use of the eight EQ knobs 50a provided on the selected channel manipulation portion 50, also enabling the user to control parameters of a compressor and delay by use of four effect knobs 50b provided on the selected channel manipulation portion 50. In addition, a display element (Safe) 50d provided on the selected channel manipulation portion 50 indicates an on/off state of the recall safe of the selected channel. When the user manipulates an isolation switch (ISO) 50c provided on the selected channel manipulation portion 50, the isolation function is activated for the selected input channel. Either the display icon (Safe) 103b and the isolation switch icon (ISO) 103a, or the display element (Safe) 50d and the isolation switch (ISO) 50c may be omitted.

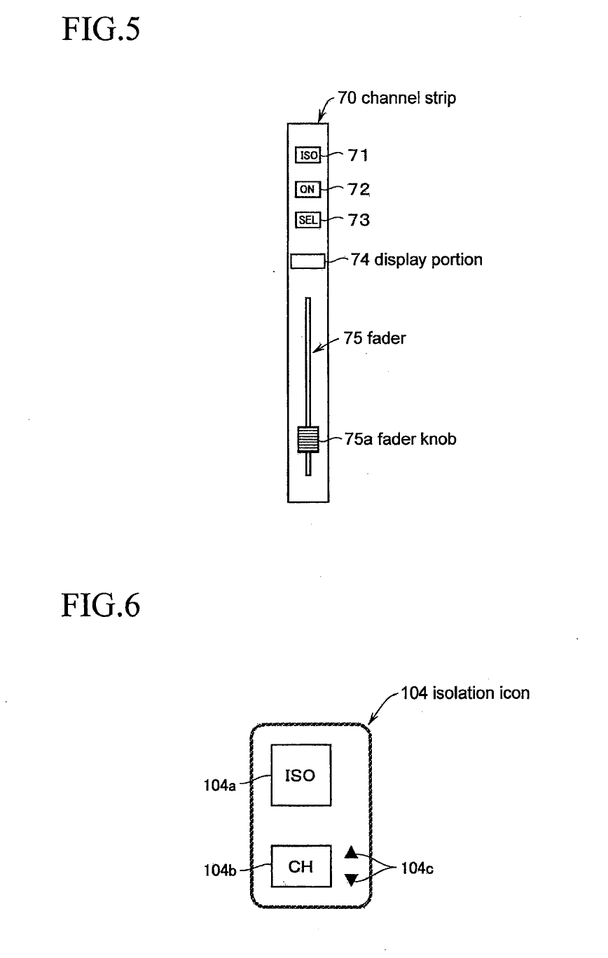

The 64 channel strips provided on the channel strip portions 53, 54 are configured similarly, respectively. FIG. 5 indicates an enlarged configuration of each channel strip. A channel strip 70 indicated in FIG. 5 has an isolation switch (ISO) 71 for isolating a channel assigned to the channel strip 70 from the batch control functions, an ON switch 72 for switching the input channel assigned to the channel strip 70 between on and off, a SEL switch 73 for selecting the assigned input channel, a display portion 74 for displaying a channel number or a channel name, and a fader 75 having a fader knob 75a for controlling the level of the assigned input channel. When the isolation switch (ISO) 71 provided on the channel strip 70 is manipulated, the isolation function is activated for the selected input channel. When the ON switch 72 is manipulated to switch off the channel, any signal will not be transmitted to the mixing buses 34a to 34k from the input channel assigned to the channel strip 70 on which the manipulated ON switch 72 is provided. When the fader knob 75a of the fader 75 is manipulated upward or downward, a volume value of the input channel assigned to the channel strip 70 on which the manipulated fader 75 is provided is controlled in accordance with the manipulation.

Instead of displaying the display icon (Safe) 103b and the isolation switch icon (ISO) 103a on the selected channel display portion 103 of the display unit 14, the mixing apparatus 1 may have a fixed display of an isolation icon 104 indicated in FIG. 6 at a given position of the display unit 14. As indicated in FIG. 6, the isolation icon 104 is formed of an isolation switch portion (ISO) 104a and a channel selection portion (CH) 104b. The user is to manipulate an up/down buttons 104c to display the channel number of his desired channel on the channel selection portion (CH) 104b to touch the isolation switch portion (ISO) 104a. By such procedures, the isolation function is activated for the selected channel displayed on the channel selection portion (CH) 104b.

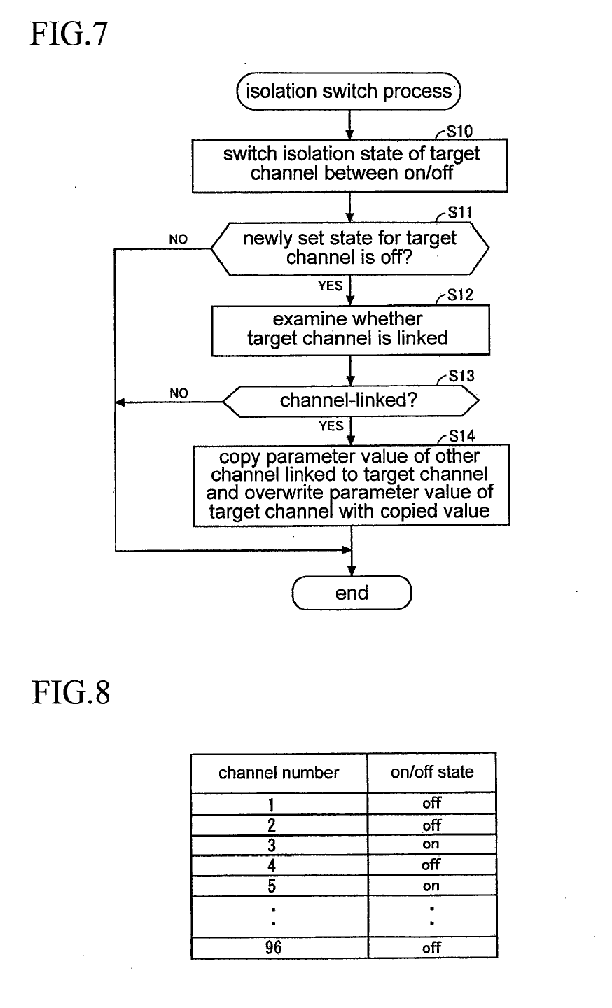

FIG. 7 indicates a flowchart of an isolation switch process carried out by the CPU 10 which serves as a control portion of the mixing apparatus 1. In order to simplify the description about the isolation switch process of this embodiment, the batch control functions which will be affected by activation of the isolation function will be regarded as two functions of the scene function and the channel link function. The isolation switch process is started when the isolation switch (ISO) 71 provided on the channel strip 70 or the isolation switch (ISO) 50c provided on the selected channel manipulation portion 50 is manipulated, or when the isolation switch icon (ISO) 103a provided on the selected channel display portion 103 is touched.

After the start of the isolation switch process, a channel assigned to the manipulated or touched isolation switch (ISO) 50c, 71 or the isolation switch icon (ISO) 103a is defined in step S10 as a target channel which is to be affected. In step S10, furthermore, the CPU 10 switches the on/off state of a later-described isolation flag of the target channel indicated in FIG. 8 to reverse the current state of the flag (if the current state is “on”, the CPU 10 switches it to “off”, whereas if the current state is “off”, the CPU 10 switches it to “on”). In a case where the flag is switched from “on” to “off”, the isolation function which has been effective for the target channel is deactivated for the channel. In a case where the flag is switched from “off” to “on”, the isolation function is activated for the target channel. Then, the CPU 10 determines in step S11 whether the newly set flag for the target channel is in the “off” state. If it is determined that the flag newly set for the target channel is in the “off” state, the CPU 10 determines that the deactivation of the isolation function is demanded to perform an isolation termination process in order to cancel the isolation for the respective batch control functions which would be affected by the isolation. As for the scene function, there is no processing required for the isolation termination process. As for the channel link function, the isolation termination process is necessary. Therefore, the CPU 10 proceeds to step S12 to refer to setting information stored in the channel link area of the RAM 12 to examine whether the target channel belongs to a channel link group and is linked with other channels. As the result of the examination, in step S13, the CPU 10 determines whether the target channel is channel-linked.

If it is determined that the target channel is channel-linked, the CPU 10 performs a process of step S14 as an isolation termination process for the channel link function. More specifically, the CPU 10 proceeds to step S14 to refer to the setting information stored in the channel link area to extract one of the channels which are linked to the target channel. From among various kinds of parameters of the extracted channel, the CPU 10 extracts parameters of such type as are controlled so that the current values of such parameters will be identical among the linked channels. In step S14, the CPU 10 then copies the current values of such parameters to replace the current values of the parameters of the target channel with the copied values. As for parameters of such type as are controlled to increase/decrease the current values by the same amount among the linked channels, the CPU 10 will not perform any processing in step S14. After the isolation termination process for the channel link function in step S14, or in a case where it is determined in step S13 that the target channel is not linked, the isolation switch process is terminated. In a case where it is determined in step S11 that the flag newly set for the target channel is in the “on” state, the CPU 10 determines that the activation of the isolation function is demanded to perform a start process for activating the isolation function for the batch control functions which will be affected by the isolation. However, the scene function and the channel link function do not require any processing as an isolation activation process. Therefore, the CPU 10 terminates the isolation switch process without performing any processing.

By performing the above-described isolation switch process, the flag indicative of the isolation state is set for the respective channels. The respective set states of the isolation flag of the respective channels are stored in a table to be stored in the isolation function area of the RAM 12 as the setting information on the isolation function. An example table of the isolation flag is indicated in FIG. 8. The table is formed of channel numbers of the respective channels and the isolation flags indicative of either on or off corresponding to the channel numbers. In the example shown in FIG. 8, the isolation flags of the channels 1, 2, 4, . . . , 96 are in the “off” state, so that in a case where these channels are controlled to have the functions of the channel link group, the DCA group and the mute group, these functions are effective for these channels, with parameters of the target channels being recalled on execution of a scene recall. The isolation flags of the other channels are in the “on” state, so that the recall safe is applied to the other channels, with the other channels being isolated all at once from the channel link group, the DCA group and the mute group to which these channels belong.

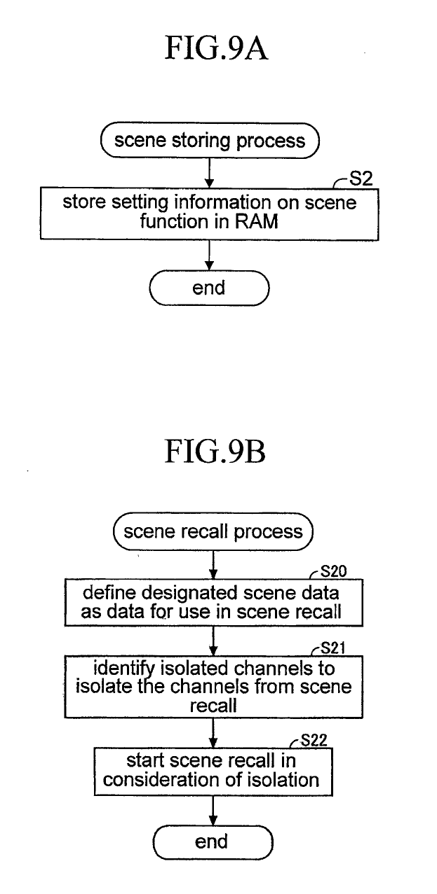

Now, the scene function will be described. FIG. 9A indicates a flowchart of a scene storing process carried out by the CPU 10 which serves as the control portion of the mixing apparatus 1. When the user demands to store a scene, the scene storing process is started. In step S2 of the scene storing process, from among parameters stored in the current area of the RAM 12, all the parameters which control the signal processing portion 18 of the mixing apparatus 1 are selected to bring together respective current values of the selected parameters as a scene data set to be stored as setting information on the scene function in the scene function area of the RAM 12. The scene function area is allowed to store a plurality of scene data sets, attaching unique scene numbers to the respective scene data sets. In addition, the scene function area also stores, as the setting information on the scene function, information indicative of channels and parameters designated by the user as those which are to be affected by the recall safe function.

Next, FIG. 9B indicates a flowchart of a scene recall process carried out by the CPU 10 which serves as the control portion of the mixing apparatus 1. When the user designates a scene number to execute a recall, the scene recall process is started. In order to allow the user to execute a recall, more specifically, the mixing apparatus 1 displays a screen for setting a scene recall on the display unit 14 to prompt the user to select a scene number and touch a recall button or manipulate a recall key which is provided on the panel but is not shown. After the start of the scene recall process, the CPU 10 defines designated scene data as data for use in the scene recall in step S20. In step S21, the CPU 10 refers to the respective states of the isolation flags stored in the table indicated in FIG. 8 to identify the isolated channels to control such that the isolated channels are isolated from the scene recall. In step S22, the scene recall is started in consideration of the isolation of the channels identified in step S21. By such a scene recall process, the execution of the scene recall will not involve the recall of the parameters of the isolated channels, preventing the current values of the parameters of the isolated channels from changing on the basis of the defined scene data. In a case where the mixing apparatus 1 has the recall safe function, furthermore, the scene recall process also identifies channels targeted by the recall safe function to isolate the channels targeted by the recall safe function from the scene recall. Therefore, the scene recall will not involve the recall of the parameters of the channels targeted by the recall safe function. In other words, the scene recall process prevents the current values of the parameters of the channels targeted by the recall safe function from changing on the basis of the defined scene data. However, the scene recall process involves the recall of the parameters of channels other than the isolated channels and the channels targeted by the recall safe function, allowing changes in the current values of the parameters of the other channels on the basis of the defined scene data.

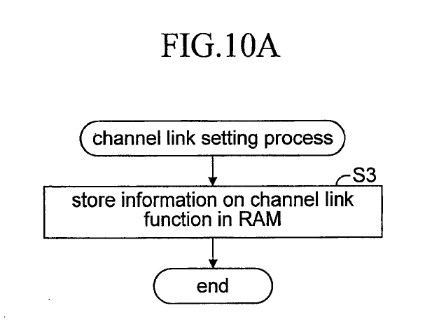

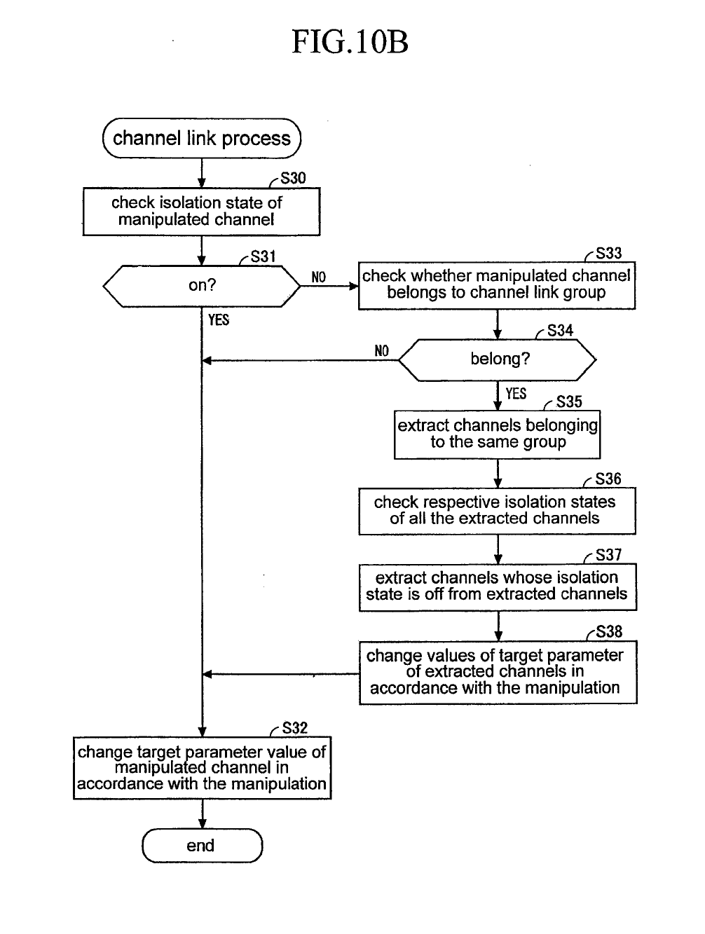

Next, the channel link function will be described. FIG. 10A indicates a flowchart of a channel link setting process carried out by the CPU 10 which serves as the control portion of the mixing apparatus 1. When the user designates a plurality of channels which the user desires to link, the channel link setting process is started. In step S3 of the channel link setting process, information indicating that the designated channels are to be linked as a grouping of channels (a channel-link group) is stored in the channel link function area of the RAM 12 as the setting information on the channel link function. The number of channel link groups which can be stored in the channel link function area is not limited to one. As for the channel link function, parameters are classified into two types according to the scheme of linking current values of the channels. One is parameters of such type as are controlled so that the current values of such parameters will be identical among the linked channels. The other is parameters of such type as are controlled to increase/decrease the current values by the same amount among the linked channels. In order to link the current values of the parameters among the channels, the respective current values of the parameters of the respective channels belonging to the channel link group are changed in either scheme according to the type of a target parameter.

FIG. 10B indicates a flowchart of a channel link process carried out by the CPU 10 which serves as the control portion of the mixing apparatus 1. When any operator of the channel strips provided on the channel strip portions 53, 54 is manipulated, the channel link process is started. In step S30, the CPU 10 checks the isolation state of the channel assigned to the channel strip having the manipulated operator. More specifically, the CPU 10 refers to the table indicated in FIG. 8 to check the on/off state of the isolation flag of the channel. In step S31, the CPU 10 determines whether the isolation flag of the channel assigned to the channel strip is in the “on” state. If it is determined in step S31 that the isolation flag of the channel is in the “on” state, the CPU 10 proceeds to step S32, for the channel is to be isolated from the channel link group. In step S32, in accordance with the manipulation of the operator, the CPU 10 changes the current value of a parameter corresponding to the manipulated operator of the channel assigned to the channel strip having the manipulated operator before terminating the channel link process. On manipulation of the operator of the channel strip to which the channel whose isolation flag is in the “on” state is assigned, therefore, the value of the parameter corresponding to the manipulated operator only of the channel is changed, even though the channel belongs to a channel link group.

If it is determined in step S31 that the isolation flag of the channel assigned to the channel strip is in the “off” state, the CPU 10 proceeds to step S33, for the channel link function is effective on the channel. In step S33, the CPU 10 refers to the setting information stored in the channel link function area of the RAM 12 to check whether the channel assigned to the channel strip having the manipulated operator belongs to a channel link group. In step S34, it is determined whether the channel belongs to a channel link group or not. If it is determined in step S34 that the channel belongs to a channel link group, the CPU 10 proceeds to step S35 to refer to the setting information stored in the channel link function area of the RAM 12 to extract all the channels which belong to the same channel link group as the channel. In step S36, the respective isolation states of all the extracted channels are checked. More specifically, the CPU 10 refers to the table indicated in FIG. 8 to check the respective on/off states of the isolation flags of the respective extracted channels to extract in step S37, from the extracted channels, channels whose isolation flag is in the “off” state. In step S38, for all the channels extracted in step S37, the CPU 10 changes respective current values of the parameter corresponding to the manipulated operator in accordance with the manipulation of the operator.

Then, the CPU 10 proceeds to step S32 to change the current value of a parameter corresponding to the manipulated operator of the channel to which the channel strip having the manipulated operator is assigned in accordance with the manipulation of the operator before terminating the channel link process. In response to the manipulation of the operator of the channel strip to which the channel whose isolation flag is in the “off” state is assigned, therefore, the respective values of the parameter corresponding to the manipulated operator of the channels which belong to the same channel link group as the channel and whose isolation flag is in the “off” state are changed. If it is determined in step S34 that the channel does not belong to any channel link group, the CPU 10 proceeds to step S32, as in the case where YES is given in step S31, to change, in accordance with the manipulation of the operator, the current value of the parameter corresponding to the manipulated operator of only the channel assigned to the channel strip having the manipulated operator.

In order to simplify the description about the channel link process indicated in FIG. 10B, the description has been given only for the case where the operator provided on the channel strip is manipulated. However, the channel link process is started when the user demands a change in a current value of any parameter of any channel.

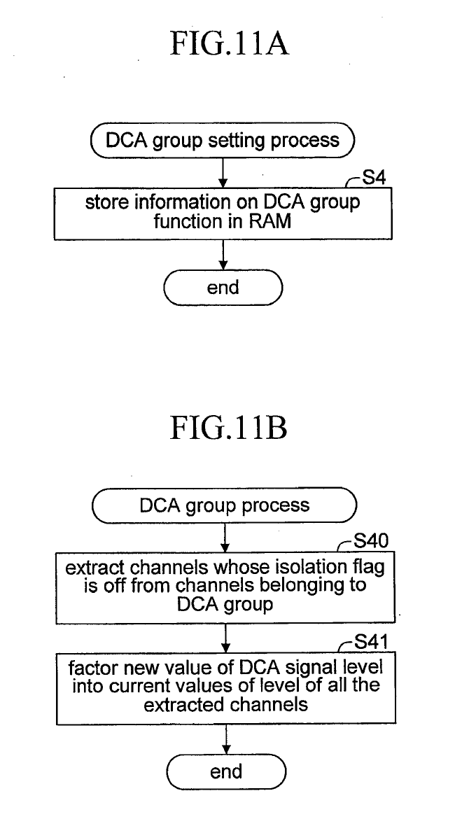

Next, the DCA group function will be described. FIG. 11A indicates a flowchart of a DCA group setting process carried out by the CPU 10 which serves as the control portion of the mixing apparatus 1. When the user designates a plurality of channels that the user desires to put together as a DCA group, the DCA group setting process is started. In step S4 of the DCA group setting process, information indicating that the designated channels form a DCA group is stored in the DCA group function area of the RAM 12 as the setting information on the DCA group function. The DCA group function area may have a plurality of DCA groups. In a case where the DCA group function is to be affected by the isolation function, if the user demands to activate the isolation function for a channel belonging to a DCA group (in a case where after it is determined that the target channel belongs to a DCA group, NO is given in step S11 in FIG. 7), an isolation start process is performed for the DCA group function. In this isolation start process, the current value of the level of the channel stored in the current area of the RAM 12 is newly provided for the signal processing portion 18. By such a process, the level of the channel is changed from a value in which a DCA signal level has been factored in to a value in which a DCA signal level is not factored in. If the user demands to terminate the isolation function for the channel belonging to a DCA group (in a case where after it is determined that the target channel belongs to a DCA group, YES is given in step S11 of FIG. 7), an isolation termination process is performed for the DCA group function. In this isolation termination process, a level obtained by factoring the current value of a DCA signal level of the DCA group to which the channel belongs into the current value of the level of the channel stored in the current area of the RAM 12 is newly provided for the signal processing portion 18. By such a process, the level of the channel is changed from the value in which the DCA signal level has not been factored in to the value in which the DCA signal level is factored in.

Next, a case where a DCA signal level of a DCA group is changed by use of a fader of the assignment strip portion 51 will be described. When a manipulation of the fader is detected, the CPU 10 which serves as the control portion of the mixing apparatus 1 performs a DCA group process indicated in a flowchart of FIG. 11B. In step S40 of the DCA group process, the CPU 10 extracts the channels whose isolation flag is in the “off” state from the channels belonging to the DCA group assigned to the assignment strip. This extraction is done by referring to the setting information stored in the DCA group function area of the RAM 12 and the table indicated in FIG. 8. In step S41, a new value of the DCA signal level is factored into the current values of the level of all the extracted channels, so that the obtained values are provided for the signal processing portion 18. Because those channels which have not been extracted from the channels belonging to the DCA group are isolated from the DCA group function by the isolation function, those channels will not be affected by the DCA group function.

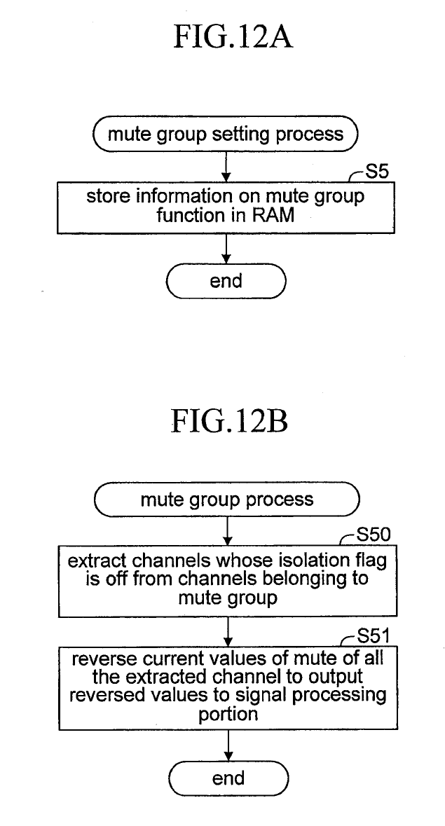

Next, the mute group function will be described. FIG. 12A indicates a flowchart of a mute group setting process carried out by the CPU 10 which serves as the control portion of the mixing apparatus 1. When the user designates a plurality of channels which are to be grouped together as a mute group, the mute group setting process is started. In step 5 of the mute group setting process, information indicating that the designated channels form a mute group is stored in the mute group function area of the RAM 12 as the setting information on the mute group function. The mute group function area may store a plurality of mute groups. In a case where the mute group function is to be affected by the isolation function, when the user demands to activate the isolation function for a channel belonging to a mute group (in a case where after it is determined that the target channel belongs to a mute group, NO is given in step S11 in FIG. 7), the isolation start process is performed for the mute group function. When the user demands to terminate the isolation function for the channel belonging to a mute group (in a case where after it is determined that the target channel belongs to a mute group, YES is given in step S11 in FIG. 7), the isolation termination process is performed for the mute group function. As for the mute group function, however, there is no processing necessary for the isolation start process and the isolation termination process. Therefore, any processing will not be performed.

Next, the switching of the mute between on and off by use of the mute switch for mute group will be described. On detection of a manipulation of the mute switch, the CPU 10 which serves as the control portion of the mixing apparatus 1. carries out a mute group process indicated in a flowchart of FIG. 12B. In step S50 of the mute group process, the CPU 10 extracts the channels whose isolation flag is in the “off” state from the channels belonging to the mute group assigned to the mute switch. This extraction is done by referring to the setting information stored in the mute group function area of the RAM 12 and the table indicated in FIG. 8. In step S51, the respective current values of the mute of all the extracted channels are reversed (if the current value is “on”, it is reversed to “off”, whereas if the current value is “Off”, it is reversed to “on”), so that the new values are provided for the signal processing portion 18. Because those channels which have not been extracted from the channels belonging to the mute group are isolated from the mute group function by the isolation function, those channels will not be affected by the mute group function.

The above-described embodiment is configured such that the channel strip portions are assigned input channels. However, the embodiment may be modified such that 32 output channels are similarly assigned to the channel strip portions, respectively. Although the embodiment is configured such that the assignment strip portion is assigned input channels and DCA groups, the assignment strip portion may be assigned output channels. In a case where output channels are assigned to the channel strip portions or the assignment strip portion, the mixing apparatus 1 operates for the output channels similarly to the case where input channels are assigned.

Although this embodiment is configured such that the channel strip portions are provided on two sides each having 32 channel strips, this embodiment may be modified such that the channel strip portions are provided on two sides each having any given number of channel strips. In addition, the number of strip portions provided on the assignment strip portion may be any given number. In this case, the maximum number of groups programmable as the DCA groups is the same as the number of strip portions.

The scheme to demand switching of the isolation flag between on and off, that is, the scheme to demand the activation or deactivation of the isolation function is not limited to the above-describe scheme to demand switching of the isolation flag of the respective channels by using the operators provided for the respective channels. Any other schemes can be adopted as long as these schemes allow designation of a target channel and demand activation or deactivation of the isolation function for the channel. For example, the mixing apparatus 1 may have separate operators for designating a channel and separate operators for demanding activation and deactivation. Alternatively, the embodiment may be modified such that the user designates a plurality of channels before simultaneously demanding activation or deactivation for the channels.

Furthermore, the types and the number of batch control functions which will be isolated by the isolation function are not limited to those of the embodiment. Any types and any number of batch control functions can be adopted as long as a plurality of (two or more) batch control functions can be isolated at a time by one manipulation. For example, this embodiment may be modified such that not only the scene function and channel link function but also the DCA group function and the mute group function can be isolated at a time. Alternatively, this embodiment may be modified to allow the user to select functions to isolate from among the batch control functions, so that the activation of the isolation function results in the isolation of a target channel from the user's selected batch control functions.

What is claimed is:

1. An audio signal processing apparatus comprising:
a signal processing portion formed of a plurality of channels each processing an input signal in accordance with a parameter;
a parameter setting portion for setting a value of a parameter for each of the channels;
a plurality of batch control function portions each performing a different batch control function which controls, all at once, respective parameter values of two or more channels included in the plurality of channels;
an isolated channel designating portion for designating any channel of the plurality of channels as an isolated channel;
an isolation portion for allowing batch control of respective parameter values by the batch control function portions for a channel which has not been designated as an isolated channel by the isolated channel designating portion and prohibiting batch control of respective parameter values by the batch control function portions for the channel which has been designated as an isolated channel by the isolated channel designating portion.

2. An audio signal processing apparatus according to claim 1, wherein
the channels whose parameter values are to be controlled all at once by the batch control function portions are designated independently function by function served by the batch control function portions.

3. An audio signal processing apparatus according to claim 1, wherein
the plurality of batch control functions are at least two of:
a scene function of reading out, all at once, changed values of various parameters stored as scene data and then controlling, all at once, respective values of the parameters in accordance with the read changed values;
a channel link function of controlling, all at once, respective values of various parameters of a plurality of channels grouped as a link group;
a DCA group function of controlling, all at once, respective values of signal level of a plurality of channels grouped as a DCA group; and
a mute group function of controlling, all at once, respective on/off states of mute of a plurality of channels grouped as a mute group.

4. An audio signal processing apparatus according to claim 1, wherein
the parameter setting portion includes a plurality of parameter operating portions assigned to the plurality of channels, respectively, in order to set respective parameter values of the plurality of channels.

5. An audio signal processing apparatus according to claim 1, wherein
the parameter setting portion includes:
a channel selection switch for selecting any channel of the plurality of channels; and
a parameter operator for setting a parameter of the channel selected by the channel selection switch.

6. An audio signal processing apparatus according to claim 1, wherein
the isolated channel designating portion is a plurality of isolation switches assigned to the plurality of channels, respectively, in order to designate the channels as isolated channels, respectively.

7. An audio signal processing apparatus according to claim 1, wherein
the isolated channel designating portion includes:
a channel selection operator for-selecting any channel of the plurality of channels; and
an isolation switch for designating the channel selected by the channel selection operator as an isolated channel.

8. An audio signal processing apparatus according to claim 1, wherein
the isolation portion has flag memory for storing a plurality of flags provided to correspond to the plurality of channels, respectively, and set by the isolated channel designating portion to indicate whether the plurality of channels have been designated as isolated channels, respectively, and prohibits, by use of the plurality of flags stored in the flag memory, batch control of respective parameter values by the plurality of batch control function portions.
